(19) United States
(12) Patent Application Publication
(10) Pub. No.: US 2022/0098514 A1
(43) Pub. Date: Mar. 31, 2022

(54) FABRIC CONDITIONING COMPOSITION

(71) Applicant: RHODIA OPERATIONS, Aubervllliers (FR)

(72) Inventors: Galder CRISTOBAL, Singapore (SG); Da Wei JIN, Singapore (SG); Siu Yu CHAN, Singapore (SG); Konstantin Nikolaev GOLEMANOV, Singapore (SG); Ritu AHUJA, Singapore (SG); Yi Ling LOW, Singapore (SG)

(21) Appl. No.: 17/414,441

(22) PCT Filed: Dec. 18, 2018
(86) PCT No.: PCT/EP2018/085497

§ 371 Date: Jun. 16, 2021

(51) Int. Cl. C11D 1/62; C11D 3/22; C11D 1/66; C11D 3/37

(52) U.S. Cl. CPC C11D 1/62; C11D 3/3742; C11D 1/662; C11D 3/222

(57) ABSTRACT

The present invention relates to a composition comprising: (a) a quaternary ammonium compound; (b) a cationic polysaccharide; (c) a non-ionic polysaccharide; and (d) an amino silicone compound having a degree of polymerization of 300 to 10,000.

### TECHNICAL FIELD

The present invention relates to a composition, notably a fabric conditioning composition. The composition comprises a quaternary ammonium compound, polysaccharides and an amino silicone compound.

### BACKGROUND

Fabric conditioning compositions are widely used for softening fabrics and imparting them nice smell. Fabric conditioning compositions can also deliver other desirable characteristics to fabrics, such as smoothness and bright colours. Fabric conditioning compositions can be utilized in a rinse cycle of an automated or non-automated washing machine, and can be utilized in hand rinsing process as well.

Fabric conditioning compositions usually incorporate softening actives, such as quaternary ammonium compounds, and other additional ingredients that can provide enhanced softening performance and various benefits. Nevertheless, the additional ingredients may bring problems to the overall properties of the compositions, for example, they may affect the overall stability of the composition, cause phase separation or cracking in the composition. Such changes in properties will be detrimental to the softening performance and/or customer satisfaction.

It is disclosed in US patent publication no. 2008/0242584 A1 that a silicone can be included in fabric softening compositions for certain benefits.

It is disclosed in PCT patent publication no. 2013/189010 A1 that a silicone and cationic polysaccharides can be added in fabric softening compositions.

It is challenging to design a fabric conditioning composition with various benefits in combination with good softening performance. It is challenging to provide additional ingredients which can enhance softening performance while have no detrimental effects to the overall properties of the fabric conditioning composition.

### SUMMARY OF INVENTION

It has been surprisingly found that the composition described herein can provide excellent fabric softening effects and is suitable for use in fabric conditioning processes.

In one aspect, there is provided a composition, notably a fabric conditioning composition, comprising:

(a) a quaternary ammonium compound;
(b) a cationic polysaccharide;
(c) a non-ionic polysaccharide; and
(d) an amino silicone compound according to the general formula (V):

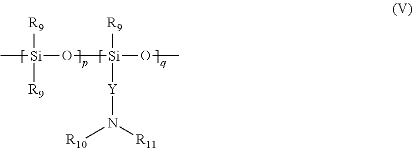

wherein:
each R₉ is independently a C₁-C₃₀ alkyl, optionally substituted;
Y is a C₁-C₃₀ alkylene, optionally substituted;
R₁₀ and R₁₁ is independently H or a C₁-C₃₀ alkyl which is optionally substituted;
the sum of p and q is in the range of 300 to 10,000, provided that q is an integer of at least 1.

The quaternary ammonium compound may have the general formula (I):

[N⁺(R₁)(R₂)(R₃)(R₄)]_{y}X⁻ (I)

wherein:
R₁, R₂, R₃ and R₄, which may be same or different, is a C₁-C₃₀ hydrocarbon group, typically an alkyl, hydroxyalkyl or ethoxylated alkyl group, optionally containing a heteroatom, or an ester or amide group;
X is an anion, for example halide such as Cl or Br, sulphate, alkyl sulphate, nitrate or acetate;
y is the valence of X.

In particular, the quaternary ammonium compound is according to the general formula (IV):

[N⁺(C₂H₄—OOCR₈)₂(CH₃)(C₂H₄—OH)](CH₃)_{z}SO₄⁻ (IV)

wherein R₈ is a C₁₂-C₂₀ alkyl group;
z is an integer from 1 to 3.

It has been found that combination of the polysaccharide system and the amino silicone compound could enhance softening performance of the composition. Surprisingly, the amino silicone compound which has a degree of polymerization of at least 300 could lead to enhanced softening performance, compared to silicones having lower polymerization degree.

The composition may be used in a rinse cycle in an automated or non-automated washing machine. Alternatively, the composition may be used in a hand rinsing process. The composition can be utilized by contacting fabrics with the composition.

### DETAILED DESCRIPTION

Throughout the description, including the claims, the term “comprising one” or “comprising a” should be understood as being synonymous with the term “comprising at least one”, unless otherwise specified, and “between” should be understood as being inclusive of the limits.

It should be noted that in specifying any range of concentration, amount or ratio, any particular upper concentration, amount or ratio can be associated with any particular lower concentration, amount or ratio, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the term “alkylene” means a, linear or branched, saturated hydrocarbon chain having a free univalent atom at each end thereof.

As used herein, the term “alkenyl” as a group or part of a group denotes an aliphatic hydrocarbon group containing at least one carbon-carbon double bond and which may be straight or branched. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

As used herein, the term “hydroxyalkyl” means an alkyl radical, which is substituted with a hydroxyl group, such as hydroxymethyl, hydroxyethyl, hydroxypropyl, and hydroxydecyl.

As used herein, the terminology “Cₙ-Cₘ” in reference to an organic group, wherein n and m are each integers, indicates that the group may contain from n carbon atoms to m carbon atoms per group.

In context of this invention, the term “fabric conditioning” is used in the broadest sense to include any conditioning benefit(s) to textile fabrics, materials, yarns, and woven fabrics. One such conditioning benefit is softening fabrics. Other non-limiting conditioning benefits include fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency; refreshing, anti-microbial, odor resistance; perfume freshness, perfume longevity, and mixtures thereof.

The term “cationic polymer” as used herein means any polymer which has a cationic charge.

The term “quaternary ammonium compound” (also referred to as “quat”) as used herein means a compound containing at least one quaternized nitrogen wherein the nitrogen atom is attached to four organic groups. The quaternary ammonium compound may comprise one or more quaternized nitrogen atoms.

The term “cationic polysaccharide” as used herein means a polysaccharide or a derivative thereof that has been chemically modified to provide the polysaccharide or the derivative thereof with a net positive charge in a pH neutral aqueous medium. The cationic polysaccharide may also include those that are non permanently charged, e.g. a derivative that can be cationic below a given pH and neutral above that pH. Non-modified polysaccharides, such as starch, cellulose, pectin, carageenan, guars, xanthans, dextrans, curdlans, chitosan, chitin, and the like, can be chemically modified to impart cationic charges thereon. A common chemical modification incorporates quaternary ammonium substituents to the polysaccharide backbones. Other suitable cationic substituents include primary, secondary or tertiary amino groups or quaternary sulfonium or phosphinium groups. Additional chemical modifications may include cross-linking, stabilization reactions (such as alkylation and esterification), phophorylations, hydrolyzations.

The term “nonionic polysaccharide” as used herein refers to a polysaccharide or a derivative thereof that has been chemically modified to provide the polysaccharide or the derivative thereof with a net neutral charge in a pH neutral aqueous medium; or a non-modified polysaccharide.

### Quaternary Ammonium Compound

According to the present invention, the quaternary ammonium compound may have the general formula (I):

[N⁺(R₁)(R₂)(R₃)(R₄)]_{y}X⁻ (I)

wherein:
R₁, R₂, R₃ and R₄, which may be same or different, is a C₁-C₃₀ hydrocarbon group, typically an alkyl, hydroxyalkyl or ethoxylated alkyl group, optionally containing a heteroatom, or an ester or amide group;
X is an anion, for example halide such as Cl or Br, sulphate, alkyl sulphate, nitrate or acetate;
y is the valence of X.

The quat preferably has the general formula (II):

[N⁺((CH₂)ₙ-T-R₅)ₘ(R₆)₄₋ₘ]_{y}X⁻ (II)

wherein:
R₅ is a C₁-C₂₄ alkyl or alkenyl group;
R₆ is a C₁-C₄ alkyl or hydroxylalkyl group;
T is —C(═O)—O—, —O—C(═O)—, —NR₇—C(═O)— or —(C═O)—NR₇—, wherein R₇ is H, or a C₁-C₆ alkyl or hydroxyalkyl group;
n is an integer from 0 to 5;
m is selected from 1, 2 and 3;
X is an anion, for example a chloride, bromide, nitrate or methosulphate ion;
y is the valence of X.

T as defined in general formula (II) is notably —C(═O)—O— or —O—C(═O)—.

Preferably, m as defined in general formula (II) is 2. Accordingly, the quaternary ammonium compound may have the general formula (III):

[N⁺((CH₂)ₙ-T-R₅)₂(R₆)₂]_{y}X⁻ (III)

wherein R₅, R₆, T, n, y and X are as defined in general formula (II).

Preferably, the average chain length of the alkyl or alkenyl group is at least C₁₄, more preferably at least C₁₆. Even more preferably at least half of the chains have a length of C₁₈. The fatty acid chains of the ester quat may comprise from 20 to 35 weight percent of saturated C₁₆ chains and from 20 to 35 weight percent of monounsaturated C₁₆ chains by weight of total fatty acid chains. Preferably, the ester quat is derived from palm or tallow feedstocks.

In one preferred embodiment, the quat is triethanolamine-based quaternary ammonium of general formula (IV):

[N⁺(C₂H₄—OOCR₈)₂(CH₃)(C₂H₄—OH)](CH₃)_{z}SO₄⁻ (IV)

wherein R₈ is a C₁₂-C₂₀ alkyl group;
z is an integer from 1 to 3.

The quaternary ammonium compound may also be a mixture of various quaternary ammonium compounds, for instance a mixture of mono-, di- and tri-ester components or a mixture of mono-, and di-ester components, wherein for instance the amount of diester quaternary is comprised between 30 and 99% by weight based on the total amount of the quaternary ammonium compound. For instance, the quaternary ammonium compound may be a mixture of mono-, di- and tri-ester components, wherein:
the amount of di-ester quaternary is comprised between 30 and 70% by weight based on the total amount of the quaternary ammonium compound, preferably between 40 and 60% by weight,
the amount of mono-ester quaternary is comprised between 10 and 60% by weight based on the total amount of the quaternary ammonium compound, preferably between 20 and 50% by weight,
the amount of tri-ester quaternary is comprised between 1 and 20% by weight based on the total amount of the quaternary ammonium compound.

Alternatively, the quaternary ammonium compound is a mixture of mono- and di-ester components, wherein:
the amount of di-ester quaternary is comprised between 30 and 99% by weight based on the total amount of the quaternary ammonium compound, preferably between 50 and 99 by weight,
the amount of mono-ester quaternary is comprised between 1 and 50% by weight based on the total amount of the quaternary ammonium compound, preferably between 1 and 20% by weight.

Examples of the preferred quaternary ammonium compounds include:

TET: Di(tallowcarboxyethyl)hydroxyethyl methyl ammonium methylsulfate,
TEO: Di(oleocarboxyethyl)hydroxyethyl methyl ammonium methylsulfate,
TES: Distearyl hydroxyethyl methyl ammonium methylsulfate,
TEHT: Dehydrogenated tallow-carboxyethyl)hydroxyethyl methyl ammonium methylsulfate,
TEP: Di(palmiticcarboxyethyl)hydroxyethyl methyl ammonium methylsulfate,
DEEDMAC: Dimethylbis[2-[(1-oxooctadecyl)oxy]ethyl]ammonium chloride.

### Cationic Polysaccharide

The cationic polysaccharide may be obtained by chemically modifying polysaccharides, generally natural polysaccharides. By such modification, cationic side groups can be introduced into the polysaccharide backbone. For instance, the cationic groups borne by the cationic polysaccharide are quaternary ammonium groups.

The cationic polysaccharides include but are not limited to: cationic cellulose and derivatives thereof, cationic starch and derivatives thereof, cationic callose and derivatives thereof, cationic xylan and derivatives thereof, cationic mannan and derivatives thereof, cationic galactomannan and derivatives thereof, such as cationic guar and derivatives thereof.

Cationic celluloses suitable for the present invention include cellulose ethers comprising quaternary ammonium groups, cationic cellulose copolymers or celluloses grafted with a water-soluble quaternary ammonium monomer.

Cellulose ethers comprising quaternary ammonium groups include the polymers sold under the names “JR” (JR 400, JR 125, JR 30M) or “LR” (LR 400, LR 30M) by the Dow Company. These polymers are also defined in the CTFA dictionary as hydroxyethylcellulose quaternary ammoniums that have reacted with an epoxide substituted with a trimethylammonium group.

Cationic cellulose copolymers or celluloses grafted with a water-soluble quaternary ammonium monomer include hydroxyalkylcelluloses, for instance hydroxymethyl-, hydroxyethyl- or hydroxypropylcelluloses grafted especially with a methacryloyl-ethyltrimethylammonium, methacrylamidopropyltrimethylammonium or dimethyl-diallylammonium salt. The commercial products corresponding to this definition are more particularly the products sold under the names Celquat® L 200 and Celquat® FI 100 by the Akzo Nobel Company.

Cationic starches suitable for the present invention include the products sold under Polygelo® (cationic starches from Sigma), the products sold under Softgel®, Amylofax® and Solvitose® (cationic starches from Avebe).

Suitable cationic galactomannans can be those derived from Fenugreek Gum, Konjac Gum, Tara Gum, Cassia Gum or Guar Gum.

Preferably, the cationic polysaccharide is a cationic guar. Guars are polysaccharides composed of the sugars galactose and mannose. The backbone is a linear chain of (B 1,4-linked mannose residues to which galactose residues are 1,6-linked at every second mannose in average, forming short side units. Within the context of the present invention, the cationic guars are cationic derivatives of guars.

In the case of the cationic polysaccharide, such as the cationic guar, the cationic group may be a quaternary ammonium group bearing 3 radicals, which may be identical or different, preferably chosen from hydrogen, alkyl, hydroxyalkyl, epoxyalkyl, alkenyl, or aryl, preferably containing 1 to 22 carbon atoms, more particularly 1 to 14 and advantageously 1 to 3 carbon atoms. The counterion is generally a halogen. One example of the halogen is chlorine.

Examples of the quaternary ammonium group include: 3-chloro-2-hydroxypropyl trimethyl ammonium chloride (CHPTMAC), 2,3-epoxypropyl trimethyl ammonium chloride (EPTAC), diallyldimethyl ammonium chloride (DMDAAC), vinylbenzene trimethyl ammonium chloride, trimethylammonium ethyl metacrylate chloride, methacrylamidopropyltrimethyl ammonium chloride (MAPTAC), and tetraalkylammonium chloride.

One example of the cationic functional group in the cationic polysaccharides, such as the cationic guars, is trimethylamino(2-hydroxyl)propyl, with a counter ion. Various counter ions can be utilized, including but not limited to halides, such as chloride, fluoride, bromide, and iodide, sulfate, notrate, methylsulfate, and mixtures thereof.

The cationic guars may be chosen from the group consisting of:

cationic hydroxyalkyl guars, such as cationic hydroxyethyl guar, cationic hydroxypropyl guar, cationic hydroxybutyl guar, and cationic carboxylalkyl guars including cationic carboxymethyl guar, cationic alkylcarboxy guars such as cationic carboxylpropyl guar and cationic carboxybutyl guar, cationic carboxymethylhydroxypropyl guar.

For instance, the cationic polysaccharide is a guar hydroxypropyltrimonium chloride or a hydroxypropyl guar hydroxypropyltrimonium chloride.

The cationic polysaccharides, such as the cationic guars, may have a weight average molecular weight (Mw) of between 100,000 Daltons and 3,500,000 Daltons, preferably between 100,000 Daltons and 1,500,000 Daltons.

In context of the present invention, the term “Degree of Substitution (DS)” of cationic polysaccharides, such as cationic guars, is the average number of hydroxyl groups substituted per sugar unit. DS may notably represent the number of the carboxymethyl groups per sugar unit. DS may be determined by titration.

The DS of the cationic polysaccharide, such as the cationic guar, may be in the range of 0.01 to 1. For instance, the DS of the cationic polysaccharide, such as the cationic guar, is in the range of 0.05 to 1. For instance, the DS of the cationic polysaccharide, such as the cationic guar, is in the range of 0.05 to 0.2.

In context of the present invention, “Charge Density (CD)” of cationic polysaccharides, such as cationic guars, means the ratio of the number of positive charges on a monomeric unit of which a polymer is comprised to the molecular weight of said monomeric unit.

The CD of the cationic polysaccharide, such as the cationic guar, may be in the range of 0.1 to 3 (meq/gm). For instance, the CD of the cationic polysaccharide, such as the cationic guar, is in the range of 0.1 to 2 (meq/gm). For instance, the CD of the cationic polysaccharide, such as the cationic guar, is in the range of 0.1 to 1 (meq/gm).

The composition may comprise from 0.05 wt % to 10 wt % of the cationic polysaccharide based on the total weight of the composition. For instance, the composition comprises from 0.05 wt % to 5 wt % of the cationic polysaccharide based on the total weight of the composition. For instance, the composition comprises from 0.2 wt % to 2 wt % of the cationic polysaccharide based on the total weight of the composition.

Non-Ionic Polysaccharide

The non-ionic polysaccharide suitable for the present invention can be a modified nonionic polysaccharide or a non-modified polysaccharide. The modified non-ionic polysaccharide may comprise hydroxyalkylation and/or esterification. In the context of the present invention, the level of modification of non-ionic polysaccharides can be characterized by Molar Substitution (MS), which means the average number of moles of substituents, such as hydroxypropyl groups, per mole of the monosaccharide unit. MS can be determined by the Zeisel-GC method.

The MS of the non-ionic polysaccharide may be in the range of 0 to 3, preferably, in the range of 0.1 to 3.

The non-ionic polysaccharide may be especially chosen from glucans, modified or non-modified starches (such as those derived, for example, from cereals, for instance wheat, corn or rice, from vegetables, for instance yellow pea, and tubers, for instance potato or cassava), amylose, amylopectin, glycogen, dextrans, celluloses and derivatives thereof (methylcelluloses, hydroxyalkylcelluloses, ethylhydroxyethylcelluloses), mannans, xylans, lignins, arabans, galactans, galacturonans, chitin, chitosans, glucuronoxylans, arabinoxylans, xyloglucans, glucomannans, pectic acids and pectins, arabinogalactans, carrageenans, agars, gum arabics, gum tragacanths, ghatti gums, karaya gums, carob gums, galactomannans such as guars and non-ionic derivatives thereof (hydroxypropyl guar), and mixtures thereof.

Among the celluloses that are especially used are hydroxyethylcelluloses and hydroxypropylcelluloses. Mention may be made of the products sold under the names Klucel® EF, Klucel® H, Klucel® LHF, Klucel® MF and Klucel® G by Aqualon, and Cellosize® Polymer PCG-10 by Amerchol, and HEC, HPMC K200, HPMC K35M by Ashland.

Preferably, the non-ionic polysaccharide is a non-ionic guar, which can be modified or non-modified. The non-modified non-ionic guars include the products sold under the name Vidogum® GH 175 by Unipectine and under the names Meypro®-Guar 50 and Jaguar® C by Solvay. The modified non-ionic guars are especially modified with C₁-C₆ hydroxyalkyl groups. Among the hydroxyalkyl groups that may be mentioned, for example, are hydroxymethyl, hydroxyethyl, hydroxypropyl and hydroxybutyl groups. These guars are well known in the prior art and can be prepared, for example, by reacting the corresponding alkene oxides such as, for example, propylene oxides, with the guar so as to obtain a guar modified with hydroxypropyl groups.

The non-ionic polysaccharide may have a weight average molecular weight (Mw) of between 100,000 Daltons and 3,500,000 Daltons, preferably between 500,000 Daltons and 3,500,000 Daltons.

The composition may comprise from 0.05 wt % to 10 wt % of the non-ionic polysaccharide based on the total weight of the composition. For instance, the composition comprises from 0.05 wt % to 5 wt % of the non-ionic polysaccharide based on the total weight of the composition. For instance, the composition comprises from 0.2 wt % to 2 wt % of the non-ionic polysaccharide based on the total weight of the composition.

The ratio between the weight of the quat and the total weight of the polysaccharides comprised in the composition may be between 2:1 and 100:1, more preferably, between 5:1 and 30:1.

The weight ratio between the cationic polysaccharide and the non-ionic polysaccharide may be between 1:10 and 10:1, more preferably, between 1:3 and 3:1.

### Silicone Compound

According to the present invention, the amino silicone compound has the general formula (V):

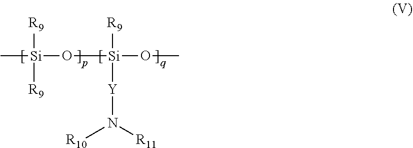

wherein:
each R₉ is independently a C₁-C₃₀ alkyl, optionally substituted; preferably a C₁-C₄ alkyl, in particular R₉ is methyl or ethyl;
Y is a C₁-C₃₀ alkylene, optionally substituted; preferably a C₁-C₁₆ alkylene, more preferably a C₁-C₈ alkylene, in particular Y is —(CH₂)₃—;
R₁₀ and R₁₁ is independently H or a C₁-C₃₀ alkyl which is optionally substituted; preferably R₁₀ and R₁₁ is independently an amino-group substituted C₁-C₃₀ alkyl, in particular R₁₀ and R₁₁ is independently —(CH₂)ᵣ—NH₂ wherein r is an integer of 1 to 10, such as r=2;
the sum of p and q is in the range of 300 to 10,000, for instance 300 to 2000, for instance from 500 to 2000, provided that q is an integer of at least 1.

It is appreciated that the sum of p and q as defined in general formula (V) represents the degree of polymerization of the amino silicone copolymer. The amino silicone copolymer typically comprises 0.5% to 20% of the amino containing monomer, calculated as molar ratio.

According to every one of the invention embodiments, the amino silicone compound is preferably according to general formula (VI):

(CH₃)₃—[O—Si(CH₃)₂]ₚ—[O—Si(CH₃){(CH₂)₃—NH—(CH₂)₂—NH₂}]_{q}—OSi(CH₃)₃ (VI)

wherein the sum of p and q is in the range of 300 to 10,000, for instance 300 to 2000, for instance from 500 to 2000, provided that q is an integer of at least 1.

Notably, said amino silicone compound has a viscosity of no less than 300 cSt, preferably no less than 900 cSt, viscosity being measured at 25° C. Viscosity of amino silicone compounds may notably be determined according to the method described in Standard ASTM D4283.

Examples of the amino silicone compound suitable for the invention include and are not limited to: XIAMETER® 8040A and XIAMETER® MEM-0949 from Dow Corning, AMS-233 from Gelest Inc., BLUESIL FLD EXTRASOFT from Bluestar, WACKER® FC 207 from Wacker, KF877, KF8704, KF880 and KF888 from ShinEtsu.

The composition may comprise from 0.05 wt % to 10 wt % of the amino silicone compound based on the total weight of the composition. For instance, the composition comprises from 0.05 wt % to 5 wt % of the amino silicone compound based on the total weight of the composition. For instance, the composition comprises from 0.2 wt % to 2 wt % of the amino silicone compound based on the total weight of the composition.

The amino silicone compound may be emulsified before addition to the composition.

### Additional Ingredients

The composition may further comprise a liquid carrier. The liquid carrier may be water or an organic solvent. Mixtures of water and organic solvent may also be used. Preferred organic solvents are: monohydric alcohol, such as ethanol, propanol, iso-propanol or butanol; dihydric alcohol, such as glycol; trihydric alcohols, such as glycerol, and polyhydric (polyol) alcohols.

The compositions may contain a fragrance material or perfume in an amount sufficient for imparting the odour to the fabrics after the treatment. In addition, it is highly desired that the fragrance material or perfume can be effectively deposited onto the fabrics and the odour provided by them can be of high intensity and be long lasting on the fabrics. As used herein, the term “fragrance material or perfume” means any organic substance or composition which has a desired olfactory property and is essentially non-toxic. Such substances or compositions include all fragrance material and perfumes that are commonly used in perfumery or in household compositions (laundry detergents, fabric conditioning compositions, soaps, all-purpose cleaners, bathroom cleaners, floor cleaners) or personal care compositions. The compounds involved may be natural, semi-synthetic or synthetic in origin.

Preferred fragrance materials and perfumes may be assigned to the classes of substance comprising the hydrocarbons, aldehydes or esters. The fragrances and perfumes also include natural extracts and/or essences, which may comprise complex mixtures of constituents, i.e. fruits such as almond, apple, cherry, grape, pear, pineapple, orange, lemon, strawberry, raspberry and the like; musk, flower scents such as lavender, jasmine, lily, magnolia, rose, iris, carnation and the like; herbal scents such as rosemary, thyme, sage and the like; woodland scents such as pine, spruce, cedar and the like.

Non limitative examples of synthetic and semi-synthetic fragrance materials and perfumes are: 7-acetyl-1,2,3,4,5,6,7,8-octahydro-1,1,6,7-tetramethylnaphthalene, α-ionone, β-ionone, γ-ionone, α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl b-naphthyl ketone, 6-acetyl-1,1,2,3,3,5-hexamethylindane, 5-acetyl-3-isopropyl-1,1,2,6-tetramethylindane, 1-dodecanal, 4-(4-hydroxy-4-methylpentyl)-3-cyclohex-ene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl)propionaldehyde, ethylvanillin, heliotropin, hexylcinnamaldehyde, amylcinnamaldehyde, 2-methyl-2-(isopropylphenyl)propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-g-benzopyran, β-naphthol methyl ether, ambroxane, dodecahydro-3a,6,6,9a-tetramethylnaphtho[2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Particular preference is given to the following: hexylcinnamaldehyde, 2-methyl-3-(tert-butylphenyl)propionaldehyde, 7-acetyl-1,2,3,4,5,6,7,8-octahydro-1,1,6,7-tetramethylnaphthalene, benzyl salicylate, 7-acetyl-1,1,3,4,4,6-hexamethyltetralin, para-tert-butylcyclohexyl acetate, methyl dihydrojasmonate, (β-naphthol methyl ether, methyl g-naphthyl ketone, 2-methyl-2-(para-isopropylphenyl)propionaldehyde, 1,3,4,6,7,8-hexahydro-4,6,6,7,8,8-hexamethylcyclopenta-g-2-benzopyran, dodecahydro-3a,6,6,9a-tetramethylnaphtho[2,1b]furan, anisaldehyde, coumarin, cedrol, vanillin, cyclopentadecanolide, tricyclodecenyl acetate and tricyclodecenyl propionates.

Other fragrance materials and perfumes are essential oils, resinoids and resins from a large number of sources, such as, Peru balsam, olibanum resinoid, styrax, labdanum resin, nutmeg, cassia oil, benzoin resin, coriander, clary sage, eucalyptus, geranium, lavender, mace extract, neroli, nutmeg, spearmint, sweet violet leaf, valerian and lavandin.

Some or all of the fragrance materials and perfumes may be encapsulated, typical perfume components which it is advantageous to encapsulate, include those with a relatively low boiling point. It is also advantageous to encapsulate perfume components which have a low C log P (i.e. those which will be partitioned into water), preferably with a C log P of less than 3.0. As used herein, the term “C log P” means the calculated logarithm to base 10 of the octanol/water partition coefficient (P).

Further suitable fragrance materials and perfumes include: phenylethyl alcohol, terpineol, linalool, linalyl acetate, geraniol, nerol, 2-(1,1-dimethylethyl)cyclo-hexanol acetate, benzyl acetate, and eugenol.

The fragrance material or perfume can be used as single substance or in a mixture with one another.

The composition of the present invention may optionally contain an oily sugar derivative. An oily sugar derivative is a liquid or soft solid derivative of a cyclic polyol (CPE) or of a reduced saccharide (RSE), said derivative resulting from 35 to 100% of the hydroxyl groups in said polyol or in said saccharide being esterified or etherified. The derivative has two or more ester or ether groups independently attached to a C₈-C₂₂ alkyl or alkenyl chain. Advantageously, the CPE or RSE does not have any substantial crystalline character at 20° C. Instead it is preferably in a liquid or soft solid state as herein defined at 20° C.

The composition may further comprise one or more of the following optional ingredients: dispersing agents, stabilizers, rheology modifying agent, pH control agents, colorants, brighteners, fatty alcohols, fatty acids, dyes, odor control agent, pro-perfumes, cyclodextrins, solvents, preservatives, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, stretch resistance agents, and mixtures thereof. Optional ingredients may be added to the composition in any desired order.

### Use of the Composition

The composition of the present invention may take a variety of physical forms including solid (such as granule), liquid, liquid-gel, paste-like, foam in either aqueous or non-aqueous form, and any other suitable form known by a person skilled in the art. For better dispersibility, a preferred form of the composition is a liquid form, and preferably in the form of an aqueous dispersion in water. When in a liquid form, the composition may also be dispensed with dispensing means such as a sprayer or aerosol dispenser.

The composition usually contains a liquid carrier and other additives, which may provide the balance of the composition. Suitable liquid carriers are selected from water, organic solvents and mixtures thereof. The liquid carrier employed in the composition is preferably water due to its low cost, safety, and environmental compatibility. Mixtures of water and organic solvent may be used. Preferred organic solvents are; monohydric alcohol, such as ethanol, propanol, iso-propanol or butanol; dihydric alcohol, such as glycol; trihydric alcohols, such as glycerol, and polyhydric (polyol) alcohols.

In the case of standard (diluted) fabric conditioning composition, the composition may contain from 0.1 wt % to 20 wt %, for instance from 0.1 wt % to 12 wt %, for instance from 1 wt % to 10 wt %, for instance from 3 wt % to 8 wt %, of a fabric conditioning agent (notably the quat).

The composition may contain higher levels, for instance up to 30 wt % or even 40 wt % of the fabric conditioning agent in the case of very concentrated fabric conditioning compositions.

In another aspect, the present invention also concerns the use of the composition according to the present invention as a textile care agent.

In still another aspect, the present invention also provides a method for conditioning a fabric by using the composition of the present invention. The method notably comprises a step of contacting the composition described herein with the fabric.

The composition of the present invention can be used in a so-called rinse process. Typically the fabric conditioning composition is added during the rinse cycle of an automatic laundry machine (such as an automatic fabric washing machine).

When being used in the rinse process, the composition is first diluted in an aqueous rinse bath solution. Subsequently, the laundered fabrics which have been washed with a detergent liquor and optionally rinsed in a first inefficient rinse step (“inefficient” in the sense that residual detergent and/or soil may be carried over with the fabrics), are placed in the rinse solution with the diluted composition. Of course, the composition may also be incorporated into the aqueous bath once the fabrics have been immersed therein. Following that step, agitation is applied to the fabrics in the rinse bath solution causing the suds to collapse, and residual soils and surfactant is to be removed. The fabrics can then be optionally wrung before drying.

### EXAMPLES

### Materials

quat: Di(palmiticcarboxyethyl)hydroxyethyl methyl ammonium methylsulfate; Fentacare® TEP obtained from Solvay;
Cationic Polysaccharide 1 (Cationic PS 1): a guar hydroxypropyltrimonium chloride having a weight average molecular weight (Mw) of below 1,000,000 Daltons;
Non-ionic Polysaccharide 1 (Non-ionic PS 1): a hydroxypropyl guar having an average molecular weight of between 1,500,000 and 2,500,000 Daltons and a MS of between 0.9 and 1.6;
the degree of polymerization and viscosity of the silicone compounds used are shown in the table below:

| | Polymerization | Viscosity |
|---|---|---|
| Silicone compounds | degree | (cSt) |
| DMS T31R, a polydimethylsiloxane | 500-550 | 800-1200 |
| (PDMS) from Gelest Inc. | | |
| XIAMETER ®8040A, an amino silicone | 600-850 | 2000-3000 |
| compound from Dow Corning | | |
| AMS-233, an amino silicone compound | 450-600 | 900-1200 |
| from Gelest Inc. | | |
| AMS-132, an amino silicone compound | 120-170 | 80-120 |
| from Gelest Inc. | | |
| AMS-162, an amino silicone compound | 90-250 | 64-200 |
| from Gelest Inc. | | |

### Sample Preparation

1. polysaccharide and water were added into a first beaker, then heated up to 55° C. with stirring.
2. quat was melt in a second beaker at 55° C. and then added into the first beaker, then the mixture was agitated for at least 5 mins.
3. The mixture of step (2) was cooled down to 35° C. and the silicones were added into the mixture.
4. The pH value of the mixture was adjusted to 2-5 with 10 wt % NaOH water solution, so as to obtain the sample composition.

### Example 1

Sample compositions were prepared according to the formulations shown in Table 1 below and according to the preparation method described above:

TABLE 1

| | Example 1 | Com. Example 1 |
|---|---|---|
| Quat | 6 wt % | 6 wt % |
| Cationic PS 1 | 0.2 wt % | 0.2 wt % |
| Non-ionic PS 1 | 0.2 wt % | 0.2 wt % |
| Xiameter ®8040A | 1 wt % | — |
| DMS T31R | — | 1 wt % |
| Water | q.s. | q.s. |

Standard cotton towels (30 cm×30 cm) were obtained from commercial sources. Fresh towels (2.5 kg total weight in each machine wash) were laundered in a Samsung top load washing machine (Model no. WA90F5S9) according to pre-set programs. The towels were subject to a Wash Cycle, followed by one Rinse Cycle (Wash Cycle: washing for 21 mins (in 47 L water); draining and spinning for 10 mins; Rinse Cycle: rinsing for 12 mins (in 47 L water)); draining and spinning for 13 mins). The sample fabric conditioning compositions (30 g for each wash) were added in the Rinse Cycle.

The treated towels were collected after the Rinse Cycle and dried in a humidity room overnight. Then the towels were subject to softness evaluation. The softness of each treated towel was evaluated by five panellists independently in which the panellist touched the treated towel and felt the softness. The softness of the treated towels was rated in a scale of 1 to 5, wherein 1 represents the lowest softness and 5 represents the highest softness. Subsequently, the average softness rating of each treatment group (n=25) was calculated. Results are shown in Table 2 below:

TABLE 2

| | |
|---|---|
| Example 1 | 3.75 |
| Com. Example 1 | 3.5 |

Results showed that the amino silicone compound led to enhanced softening effects compared to PDMS which is not an amino containing silicone.

### Example 2

Sample compositions were prepared according to the formulations shown in Table 3 below and according to the preparation method described above:

TABLE 3

| | Example 2 | Example 3 | Com. Ex. 2 | Com. Ex. 3 | Com. Ex. 4 |
|---|---|---|---|---|---|
| Quat | 6 wt % | 6 wt % | 6 wt % | 6 wt % | 6 wt % |
| Cationic PS 1 | 0.2 wt % | 0.2 wt % | 0.2 wt % | 0.2 wt % | 0.2 wt % |
| Non-ionic PS 1 | 0.2 wt % | 0.2 wt % | 0.2 wt % | 0.2 wt % | 0.2 wt % |
| Xiameter ®8040A | 1 wt % | — | — | — | — |
| AMS-233 | — | 1 wt % | — | — | — |
| AMS-132 | — | — | 1 wt % | — | — |
| AMS-162 | — | — | — | 1 wt % | — |
| Water | q.s. | q.s. | q.s. | q.s. | q.s. |

The softening performance test was conducted as described in Example 1 and the results are shown in Table 4 below:

TABLE 4

| | |
|---|---|
| Example 2 | 3.7 |
| Example 3 | 3.8 |
| Com. Ex. 2 | 3.5 |
| Com. Ex. 3 | 3.5 |
| Com. Ex. 4 | 3.5 |

Results showed that the amino silicone compounds according to the invention which have degree of polymerization above 300 led to enhanced softening effects, compared to those having degree of polymerization below 300.

1. A composition comprising:
(a) a quaternary ammonium compound;
(b) a cationic polysaccharide;
(c) a non-ionic polysaccharide; and
(d) an amino silicone compound according to the general formula (V): 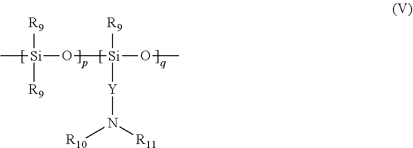
wherein:
each R₉ is independently a C₁-C₃₀ alkyl, optionally substituted;
Y is a C₁-C₃₀ alkylene, optionally substituted;
R₁₀ and R₁₁ is independently H or a C₁-C₃₀ alkyl which is optionally substituted;
the sum of p and q is in the range of 300 to 10,000, provided that q is an integer of at least 1.

2. The composition according to claim 1, wherein the quaternary ammonium compound has the general formula:
[N⁺(R₁)(R₂)(R₃)(R₄)]_{y}X⁻ (I)
wherein:
R₁, R₂, R₃ and R₄, same or different, is a C₁-C₃₀ hydrocarbon group, optionally containing a heteroatom, or an ester or amide group;
X is an anion;
y is the valence of X.

3. The composition according to claim 2, wherein at least one of R₁, R₂, R₃ and R₄ as defined in general formula (I) contains an ester or amide group.

4. The composition according to claim 1, wherein the quaternary ammonium compound has the general formula:
[N⁺((CH₂)ₙ-T-R₈)ₘ(R₉)₄₋ₘ]_{y}X⁻ (III)
wherein:
R₈ is a C₁-C₂₄ alkyl or alkenyl; R₉ is a C₁-C₄ alkyl or hydroxylalkyl;
T is —C(═O)—O—, —O—C(═O)—, —NR₁₀—C(═O)— or —(C═O)—NR₁₀—, wherein R₁₀ is H, a C₁-C₆ alkyl or a C₁-C₆ hydroxyalkyl;
n is an integer from 0 to 5; m is selected from 1, 2 and 3;
X is an anion; y is the valence of X.

5. The composition according to claim 1, wherein the quaternary ammonium compound is according to the general formula (IV):
[N⁺(C₂H₄—OOCR₈)₂(CH₃)(C₂H₄—OH)](CH₃)_{z}SO₄⁻ (IV)
wherein R₈ is a C₁₂-C₂₀ alkyl;
z is an integer from 1 to 3.

6. The composition according to claim 1, wherein the cationic polysaccharide is a cationic guar.

7. The composition according to claim 1, wherein the non-ionic polysaccharide is a non-ionic guar.

8. The composition according to claim 1, wherein the amino silicone compound is according to the general formula (VI):
CH₃)₃—[O—Si(CH₃)₂]ₚ—[O—Si(CH₃){(CH₂)₃—NH—(CH₂)₂—NH₂}]_{q}—OSi(CH₃)₃ (VI)
wherein the sum of p and q is in the range of 300 to 10,000, provided that q is an integer of at least 1.

9. The composition according to claim 1, wherein the amino silicone compound has a viscosity of no less than 300 cSt, the viscosity being measured at 25° C.

10. The composition according to claim 1, wherein the ratio between the weight of the quaternary ammonium compound and the total weight of the polysaccharides comprised in said composition is between 2:1 and 100:1.

11. The composition according to claim 1, wherein said composition further comprises a fragrance material or perfume.

12. The composition according to claim 1, wherein the composition comprises the quaternary ammonium compound in an amount of from 1 wt % to 10 wt %, based on total weight of the composition.

13. The composition according to claim 1, wherein the composition is a fabric conditioning composition.

14. The composition according to claim 1, wherein the composition is a textile care agent.

15. A method for conditioning a fabric, the method comprising a step of contacting the fabric with the composition according to claim 1.
